(19) United States
(12) Patent Application Publication
(10) Pub. No.: US 2006/0007375 A1
(43) Pub. Date: Jan. 12, 2006

(54) Phase retarder, a laminate polarizing plate a method for producing thereof, and a liquid crystal display

(75) Inventors: Tohru Nagashima, Niihama-shi (JP); Yuichiro Kunai, Niihama-shi (JP); Yoshiki Matsuoka, Niihama-shi (JP); Takahiro Kawamura, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/157,784

(22) Filed: Jun. 22, 2005

(30) Foreign Application Priority Data
Jun. 24, 2004 (JP) 2004-186037

(51) Int. Cl. G02F 1/1335

(52) U.S. Cl. 349/117

(57) ABSTRACT

The invention provides a phase retarder comprising a film which comprises a compound comprising an organic modified clay composite, and a urethane resin which comprises aliphatic diisocyanate, wherein the weight ratio of the former to the latter is more than 2 to less than 5.

### BACKGROUND OF THE INVENTION

1. Field of the Invention

The present invention relates to a phase retarder and laminate polarizing plate using the phase retarder, a method of producing thereof and a liquid crystal display comprising the phase retarder.

2. Description of the Related Art

Liquid crystal displays which have characteristics of low power consumption, low drive voltage, light weight and flat panel, rapidly spread to devices displaying information such as cellular phones, handheld terminals, monitors for computer and televisions. On account of development of liquid crystal cell technologies, liquid crystal displays having various modes are proposed and it is getting to solve the problems of liquid crystal display relating response speed, contrast and narrow viewing angle. The liquid crystal displays, however, are still pointed out on the problem of their narrower viewing angle compared with cathode ray tubes (CRT): hence, various attempts have been done to expand their viewing angle.

As one of liquid crystal displaying methods to improve the viewing angle, for example, Japanese Patent No. 2548979 discloses a vertical-alignment mode nematic type liquid crystal display (VA-LCD). The vertical-alignment mode passes light through liquid crystal layer without changing polarization thereof due to liquid crystal molecules being aligned vertically against substrate in non-driving state. Therefore, by placing linear polarizing plates on and under a liquid crystal panel in a manner of their polarization axes being orthogonal each other, it is achieved to obtain almost complete black indication giving high contrast ratio when being viewed from front side.

However, the vertical-alignment mode liquid crystal displays equipping only polarizing plates to a liquid crystal cell, when viewed from inclined directions, remarkably decreases contrast by light leakage due to deviation of viewing angle to the equipped polarizing plates from 90°, and generating birefringence on rod-like liquid crystal molecules in the cell.

To depress this light leakage, it is necessary to dispose optical compensation films between a liquid crystal cell and linear polarizing plates: for this purpose, conventionally applied methods include the method that each one of biaxial phase retarder films being independently disposed between a liquid crystal cell and, respective upper and lower polarizing plates: the method that each one of an uniaxial phase retarder film and a completely biaxial phase retarder film being independently disposed respectively on and under a liquid crystal cell; or the method that both of an uniaxial phase retarder film and a completely biaxial phase retarder film being co-disposed at one side of a liquid crystal cell. JP-A No. 2001-109009 discloses that, in a vertical-alignment mode liquid crystal display, each of an a-plate (positive uniaxial phase retarder film) and a c-plate (completely biaxial phase retarder film) is independently disposed between a liquid crystal cell, and respective upper and lower polarizing plates.

The positive uniaxial phase retarder film is a film of which ratio R₀/R′ of an in-plane retardation value (R₀) to a retardation value in a thickness direction (R′) is approximately 2: and the completely biaxial phase retarder film is a film of which in-plane retardation value (R₀) is nearly zero. When letting n, to the refractive index of in-plane slow axis of film, n_{y} to the refractive index of in-plane fast axis of film, nₓ to the refractive index in thickness direction, and d to the film thickness, the in-plane retardation value R₀ and the retardation value in a thickness direction R′ are respectively defined by the following formula (I) and (II).
R₀=(nₓ−n_{y})×d (I)
R′=[((nₓ+n_{y})/2−n_{z})×d (II)

Due to n_{z}≈n_{y} in a positive uniaxial phase retarder film, it results R₀/R′≈2. Even in a uniaxial phase retarder film, R₀/R′ varies in a range approximately 1.8 to 2.2 due to fluctuation of film elongation conditions. Due to nₓ≈n_{y} in a completely biaxial phase retarder film, it results R₀≈0. Since the completely biaxial phase retarder film is a film of which refractive index is different (or smaller) only in a thickness direction, it has a negative uniaxial phase retardation, and is alternatively called a film having an optical axis in normal line or, as aforementioned, a c-plate. The biaxial phase retarder film attains nₓ>n_{y}>n_{z}.

U.S. Pat. No. 6,060,183 (corresponding to JP-A No. H10-104428) discloses that a complete biaxial phase retarder film is formed by a coating layer containing an organic modified clay composite able to disperse in an organic solvent. A laminate polarizing plate obtained by the laminating the coating layer on polarizing plate in the prescribed manner has a simplified constitution, and therefore, the laminate polarizing plate provide a excellent viewing angle as well as the simplified constitution.

### SUMMARY OF THE INVENTION

However, when laminate polarizing plates are formed by layering phase retarders composed of coating layers including organic modified clay composites and applied to liquid crystal displays, haze derived from the phase retarders often causes depolarization and results in reduction of contrast ratio.

The inventors of the invention have diligently studied to solve such problems, and consequently found that these problems can be solved by applying a specific resin as a binder to phase retarders composed of coating layers including organic modified clay composites, and achieved the present invention. An object of the invention is to provide a phase retarder which is formed by a coating layer including a organic modified clay composite and has improved haze value, and a method for producing thereof. Another object of the invention is to provide a laminate polarizing plate which is composed by layering the phase retarder with a polarizing plate and is effective to enhance viewing angle characteristics of liquid crystal displays, and a method for producing thereof. Further other object of the invention is to provide a liquid crystal display which is structured by combining the laminate polarizing plate and a liquid crystal cell and has enhanced viewing angle characteristics and high contrast ratio.

That is, the invention provides a phase retarder comprising a film which comprises a compound comprising an organic modified clay composite, and a urethane resin which comprises aliphatic diisocyanate, wherein the weight ratio of the former to the latter is more than 2 to less than 5.

The advantageous urethane resin is a resin wherein aliphatic diisocyanate is isophorone diisocyanate. The advantageous organic modified clay composite is a composite of a quaternary ammonium compound having alkyl group having 1 to 30 carbon atoms and a clay mineral belonging to smectite group.

This phase retarder allows a haze value to be equal to or less than 2%, especially equal to or less than 1.5%. The phase retarder preferably has a in-plane retardation value R₀ of 0 to 10 nm and a retardation value R′ in the film-thickness direction of 40 to 300 nm.

The phase retarder can be produced by coating on a substrate a compound including the organic modified clay composite, the urethane resin composed of aliphatic diisocyanate and an organic solvent, followed by remobving the organic solvent therefrom.

The invention provides a laminate polarizing plate in which a polarizing plate, an adhesive and any of phase retarders described above are layered in this order. In this laminate polarizing plate, a second adhesive layer may be further formed at the outer side of the phase retarder.

The laminate polarizing plate can be advantageously produced by procedures including: a step of forming the phase retarder by coating on a substrate the compound including the organic modified clay composite and the urethane resin composed of aliphatic diisocyanate; a step of preparing the polarizing plate having the adhesive; a step of adhering the adhesive layer of the polarizing plate having the adhesive, with the exposed surface of the coated phase retarder; and then a step of peeling the substrate away from the coated phase retarder.

The invention further provides a liquid crystal display having the laminate polarizing plate described above and a liquid crystal cell. In this display, the laminate polarizing plate is placed on the one side of the liquid crystal cell in a manner that its phase retarder side being faced towards the liquid crystal cell, that is, that the phase retarder being situated to face the liquid crystal cell rather than the polarizing plate being. When a second adhesive layer is formed on an outer side of the phase retarder, the phase retarder is adhered with the liquid crystal cell by interposing the second adhesive layer. On the other side of the liquid crystal cell, a second phase retarder of which in-plane retardation value R₀ is 30 to 300 nm and ratio R₀/R′ of the in-plane retardation value R₀ to the retardation value R′ in the film-thickness direction is more than 0 and less than 2, and a second polarizing plate, are disposed in this order; this disposition enhances viewing angle characteristics of the liquid crystal cell.

### BRIEF DESCRIPTION OF THE DRAWING

FIG. 1: A schematic sectional view exemplifying outline of the laminate polarizing plate.

FIG. 2: An example of schematic sectional view exemplifying outline of a production process of the laminate polarizing plate.

FIG. 3: A schematic sectional view exemplifying outline of a process of from a step of forming coating layer to a step of laminating a polarizing plate with a adhesive layer thereon when a laminate polarizing plate is produced in rolled form.

FIG. 4: A schematic sectional view exemplifying outline a process of forming a second adhesive layer on a laminate polarizing plate.

FIG. 5: A schematic sectional view exemplifying outline of consecutively carrying out from a step of forming a coating layer to a step of forming a second adhesive layer.

FIG. 6: A schematic sectional view exemplifying outline of an example of a liquid crystal display relating to the present invention.

10—Laminate polarizing plate

11—Polarizing plate

12—Adhesive layer

13—Polarizing plate with adhesive

14—Release film of polarizing plate

15—Phase retarder comprising a coating layer

16—Second adhesive layer

17—Release film of adhesive layer

18—A film with adhesive

19—Transfer substrate

20—Transfer substrate after peeled off

21—Semi-finished product

30—Transfer substrate roller

32—Coating layer coater

34—Coating layer drying zone

36—Polarizing plate roller

38—Release film rolling in roller

40—Semi-finished product roller

41—Semi-finished product turning roller

43—Transfer substrate peeling off roller

44—Transfer substrate rolling in roller

45—Film with an adhesive roller

46—Adhesive coater

47—Adhesive drying zone

48—Release film roller

50—Product roller

60—liquid crystal cell

62—Second phase retarder

64—Second polarizing plate

### PREFERABLE EMBODIMENT OF THE INVENTION

The invention is explained in more detail. Firstly, the phase retarder is explained. The phase retarder of the invention is a film molded from a compound including an organic modified clay composite and a urethane resin composed of aliphatic diisocyanate, wherein the weight ratio of the former to the latter is more than 2 to less than 5. The film is provided in a form of film consisting of the compound itself or of coated film consisting of the compound coated on a supporting substrate.

The urethane resin composed of aliphatic diisocyanate is produced by subjecting an aliphatic compound having plural isocyanate groups in the molecule thereof to addition reaction with a compound having plural active hydrogens such as hydroxy group in the molecule thereof. The aliphatic compound having plural isocyanate groups in the molecule thereof, includes hexamethylene diisocyanate, dicyclohexylmethane diisocyanate, hexane diisocyanate, hydrogenated xylylene diisocyanate, isophorone diisocyanate, norbornene diisocyanate and the like. Of these, the compound composed of isophorone diisocyanate is particularly preferable.

The compound having plural active hydrogens in the molecule thereof includes polyether polyol, polyester polyol, polycarbonate polyol, polycaprolactone polyol and the like. Of these, polyether polyol and polyester polyol are preferably employed, but not limited thereto; the mixture of above polyols may be employed.

The polyether polyol is, for example, produced by ring-opening polymerizing or copolymerizing cyclic ethers such as ethylene oxide, propylene oxide, trimethylene oxide, butylene oxide, a-trimethylene oxide, 3,3-dimethyltrimethylene oxide, tetrahydrofuran, dioxane and the like; and is often called polyether glycor,polyoxyalkylene glycol.

The polyester polyol is produced by polycondensing polybasicity organic acids especially such as dicarboxylic acids, and polyols. The dicarboxylic acid includes, for example, saturated aliphatic acids such as oxalic acid, succinic acid, glutaric acid, adipic acid, pimelic acid, suberic acid, azelaic acid, sebacic acid and isosebacic acid; unsaturated aliphatic acids such as maleic acid and fumaric acid; and aromatic calboxylic acids such as phthalic acid and isophthalic acid. The polyols include, for example, diols such as ethylene glycol, diethylene glycol, triethylene glycol, propylene glycol and butylene glycol: triols such as trimethylolpropane, trimethylolethane, hexanetriol and glycerin; and hexaols such as sorbitol: but are not limited thereto and a mixture of at least two kinds thereof may be applied.

The glass-transition temperature of the urethane resin is preferably equal to or less than 20° C., more preferably equal to or less than −20° C. The urethane resin having high glass-transition temperature is insufficient in rubber elasticity and often has drawbacks in adhesiveness and flexibility for being applied to phase retarders or laminate polarizing plates in which such phase retarders being layered with polarizing plates.

The organic modified clay composite, as described, is a composite of an organic compound and a clay mineral, more specifically, for example, a combined substance of a clay mineral having laminar structure and an organic compound. The clay minerals having laminar structure includes a smectite group or a swellable mica, of which positive ion exchangeability enables to combine with organic compounds. Among of them, the smectite group is preferably employed due to its excellent transparency. Examples belonging to the smectite group are hectorite, montmorillonite, bentonite and the like, substituteds thereof, derivatives thereof and mixtures thereof. Among those, the synthesized is preferable due to little contamination with impurities and excellent transparency. The synthetic hectorite whose particle diameter is controlled to be small is particularly preferably used due to its ability to suppress scattering of visible lights.

The organic compounds combined with clay minerals include compounds capable of reacting with oxygen atoms and hydroxyl groups of the clay mineral or an ionic compounds capable of exchanging with exchangeable cations; which are not particularly limited as long as the resultant organic modified clay composite can be swelled or dispersed in an organic solvent, specifically included are nitrogen-containing compounds and the like. The nitrogen-containing compound includes, for example, a primary, a secondary or a tertiary amine, a quaternary ammonium compound, urea, hydrazine, and the like. Of these, the quaternary ammonium compound is preferable due to its ability to easily exchange cations.

The quaternary ammonium compound includes, for example, compounds having long-chain alkyl groups or alkylether chain. Of these, preferable are the quaternary ammonium compounds having alkyl group having 1 to 30 carbon atoms, —(CH₂CH(CH₃)O)ₙH group having a range of n=1 to 50, or —(CH₂CH₂CH₂O)ₙH group having a range of n=1 to 50; more preferable is the one having alkyl group having 6 to 10 carbon atoms.

The organic modified clay composites may be used by combining two or more kinds thereof. Suitable commercialized organic modified clay composite includes the composite compound of synthetic hectorite and a quaternary ammonium compound manufactured by CO-OP Chemical Co., LTD. in the trade name of Lucentite STN or Lucentite SPN.

In the invention, the organic modified clay composite and the urethane resin are blended in a range of more than 2 to less than 5 by weight ratio of organic modified clay composite by urethane resin. If the blending ratio exceeds the range, it is difficult to keep the haze value of the phase retarder obtained within desired extent. The weight ratio of blending both materials is preferably equal to or more than 2.5.

The haze value of the phase retarder of the invention is preferably equal to or less than 1.5%, more preferably equal to or less than 1.0%. If the haze value exceeds 1.5%, depolarization is caused due to scattering of linearly polarized light transmitted and often results in reduction of contrast of the liquid crystal display which employing such phase retarder. The haze value is also called a cloudy value which is defined in the direction of JIS K 7105 by the formula of (diffuse transmission factor/total light transmission factor)×100(%). The haze value may be reduced by employing the specif IC urethane resin described above as a binder in a predetermined ratio.

The phase retarder is preferably produced by a method that the organic modified clay composite and the urethane resin are dispersed or dissolved in an organic solvent to form a coating solution, followed by being coated on a flat substrate and then dried. By being subjected to the coating and drying, the unit crystal layer of the organic modified clay composite is formed in a layered structure which is parallel to the flat substrate face and has random orientation in its in-plane direction. Consequently, without special orientating treatment, a refractive index structure in which the value of in-plane refractive index is greater than that of refractive index in the film-thickness direction, is achieved.

The organic solvent employed to the coating solution is not particularly limited, for example, included are low-polarity aromatic hydrocarbons such as benzene, toluene and xylene: ketones such as acetone, methyl ethyl ketone and methyl isobutylene ketone; lower alcohols such as methanol, ethanol and propanol: and high polar solvents including halogenated hydrocarbons such as carbon tetrachloride, chloroform, dichloromethane and dichloroethane—of these, toluene, xylene, acetone and methyl isobutylene ketone and a mixture thereof are preferable due to capability to disperse the organic modified clay composite, dissolve the urethane resin and prevent the coating solution from gelation.

A concentration of solid in the dispersed solution is not limited as long as gelation or turbidity of the prepared dispersed solution is occurred to the extent not causing troubles in practical usage; usually applied range is 3 to 15% by weight in terms of the total of the solid concentration of the organic modified clay composite and the urethane resin. Since the optimal solid concentration varies depending on the kind or the composition ratio of organic modified clay composites or urethane resin employed respectively, it is determined on each case of the composition. Various additives such as a viscosity adjust or for improving layer formability in case of forming a layer on a transfer substrate, a crosslinking agent for further improving the hydrophobic nature and/or durability, and the like, may also be added.

The substrate on which the coating solution is coated to obtain the phase retarder of the invention, is not particularly limited, for example, included is a polyethylene terephthalate film subjected to mould releasing treatment. The temperature and time are not particularly limited as far as those being sufficient to eliminate the solvent employed, for example, may be optionally chosen from the temperature range of 50° C. to 15020 C., and from the time range of 30 seconds to 30 minutes.

The preferable in-plane retardation value R₀ of the phase retarder of the present invention is 0 to 10 nm and the retardation value in the thickness direction R′ is 40 to 300 nm. It is not preferable that the in-plane retardation value R₀ exceeds 10 nm, because the exceeded value is not neglectable and deteriorates a negative uniaxiality in the thickness direction.

The retardation value in the film-thickness direction R′ is appropriately selected according to applications of the phase retarder, especially to properties of the liquid crystal cell which is applied by being adhered with the laminate polarizing plate; the value is particularly preferably in the extent of 50 to 200 nm. The retardation value in the film-thickness direction R′ is can be controlled by the coated thickness of the coating solution. Therefore, the film thickness to form dried phase retarder is not particularly limited as long as the thickness realizes phase retardation property required to the phase retarder.

The refractive index anisotropy in the thickness direction is represented by the retardation value in the thickness direction R′ which being defined by the formula (II) described above; and can be calculated from a retardation value R₄₀ which is measured in 40° inclined state by applying the in-plate slow axis as an inclined axis, and the in-plane retardation value R₀.

The retardation value in the thickness direction R′ defined by the formula (II) can be calculated as follows; using the in-plane retardation value R₀, the retardation value R₄₀ measured in 40° inclined state by applying the in-plate slow axis as an inclined axis, the film thickness d and the average refractive index of film no, the nₓ, n_{y} and n_{z} are obtained from the following formulas by numerical computation, and the results of the numerical computation are substituted in the aforementioned formula (II).
R₀=(nₓ−n_{y})×d (III)
R₄₀=(nₓ−n_{y})×d/cos(f) (IV)
(nₓ+n_{y}+n_{z})/3=n₀ (V),
wherein
f=sin⁻¹ [sin(40°)/n₀]
n_{y}′=n_{y}×n_{z}/[n_{y}²×sin²(f)+n_{z}²×cos²(f)]^{1/2}

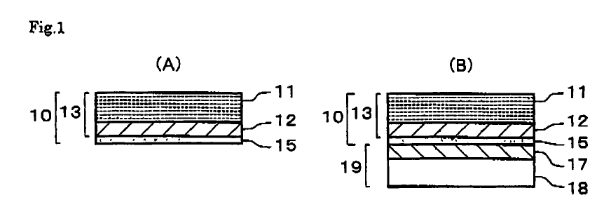

The laminate polarizing plate is explained. The laminate polarizing plate of the invention is, as shown in FIG. 1(A), a composite layer layering the polarizing plate 11, the adhesive layer 12 and the phase retarder 15 described above, in this order. The polarizing plate 11 and the adhesive layer 12 are usually prepared in a form of a polarizing plate with adhesive 13. The phase retarder 15 includes a coating layer having refractive index anisotropy, and the coating layer may includes single layer or a multilayer having at least 2 layers.

The laminate polarizing plate 10 is usually applied by being adhered with a liquid crystal cell in a manner of disposing the phase retarder 15 thereof to face the side of the liquid crystal cell, to say another words, disposing the polarizing plate 11 thereof to the outer side against the liquid crystal cell. Therefore, to be adhered with the liquid crystal cell, the second adhesive layer 17 may be disposed to the outer side of the phase retarder 15, as shown in FIG. 1(B). In this case, a release film 18 is further disposed to the outer side of the second adhesive layer 17, and then the release film 18 disposed is peeled away to subject the liquid crystal cell to adhesion with the surface of second adhesive layer 17. A film with adhesive 19 may be prepared by disposing the adhesive layer 17 on the release film 18, and then the side of adhesive layer 17 thereof being layered with the coating layer 15.

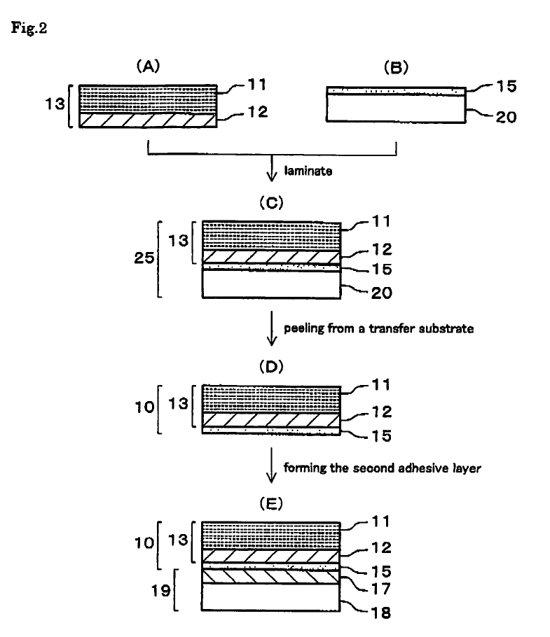

As a method to produce the laminate polarizing plate of the invention, exemplified is that the phase retarder 15 including a coating layer is formed on a transfer substrate, followed by being transferred on the surface of adhesive layer 12 of the polarizing plate with adhesive 13. This example is explained by referring FIG. 2.

Firstly, as shown in FIG. 2(A), the adhesive layer 12 is formed on the surface of the polarizing plate 11 to prepare a polarizing plate with adhesive 13. Independently, as shown in FIG. 2(B), the coating layer 15 is formed on the surface of a transfer substrate 20. Thereafter, the adhesive layer 12 of the polarizing plate with adhesive 13 shown in (A) is adhered with the coating layer 15 on the transfer substrate 15 shown in (B) to produce a semi-finished product 25 having a layer structure, as shown in FIG. 2(C), of polarizing plate 11/adhesive layer 12/coating layer 15/transfer substrate 20. Then,after peeling the transfer substrate 20 away as shown FIG. 2(D), a laminate polarizing plate 10 shown in FIG. 1(A) is obtained. Thereafter, on the surface of phase retarder 15 including a coating layer after the transfer substrate being peeled away, a second adhesive layer 17 and a release film 18 are disposed as shown in FIG. 2(B) to obtain a laminate polarizing plate 10 with adhesive layer 17 shown in FIG. 1(B). The second adhesive layer 17 may be formed by directly coating an adhesive on the coating layer 15, or by pre-coating an adhesive on the release film 18 and drying to prepare a film with adhesive 19, followed by the side of adhesive layer 17 thereof being adhered with the coating layer 15.

As alternation, to enhance adhesiveness between the adhesive 12 and the phase retarder 15, or between the phase retarder 15 and the second adhesive 17, the surface of any of layers may be subjected to corona treatment.

The polarizing plate 11 employed to the laminate polarizing plate is not particularly limited as far as it has selective transmissivity to linearly polarized light in a specific vibration direction. Specifically, included are resin films such as polyvinylalcohol system in which dichroic dyes being absorbed and oriented. Typically applied dichroic dyes are iodine or dichroic organic dyes. Exemplified polarizing plates are a mono-oriented polyvinylalcohol having absorbed and oriented iodine molecules, or a mono-oriented polyvinylalcohol having absorbed and oriented azo dichroic dye. The polyvinylalcohol polarizing plates having absorbed and oriented dichroic dyes, have functions of absorbing a linearly polarized light having vibration face in the oriented direction of the dichroic dyes, and of transmitting a linearly polarized light having orthogonal vibration face in the oriented direction.

These polarizing plates are usually applied in a form that one side or both sides of the polyvinylalcohol polarizing film is protected by a layer of polymer films such as triacetylcellulose film and the like. When the polarizing plate has a protecting layer at only one side thereof, in consideration of adhesion with a liquid crystal cell, the side having the protecting layer is disposed to the outer side against the liquid crystal cell, and the side without the protecting layer being to face toward the adhesive layer 12.

Adhesive used in the present invention includes the one having base polymers such as acrylic resins, silicone resins, polyesters, polyurethanes, polyethers and the like. Of those, the preferably applied is the one selected from the adhesives, like acrylic resin adhesives, having properties of excellent optical transparency, retaining appropriate wettability and cohesive power, excellent adhesive ability to substrate, weather and temperature resistances, not causing exfoliation problems such as floating up, peeling off or the like under heated or humid conditions. In the acrylic resin adhesives, the useful base polymer is an acrylic copolymer resin having a weight average molecular weight of equal to or more than 100 thousand which being polymerized by blending methacrylic acid alkyl esters and acrylic monomers containing a functional group to make the glass transition temperature of the resultant copolymer being preferably equal to or less than 25° C., more preferably equal to or less than 0° C.; the methacrylic acid alkyl esters which having an alkyl group having carbon atoms of equal to or less than 20 such as a methyl group, an ethyl group, a butyl group and the like: and the acrylic monomers containing functional group which including a methacrylic acid, a methacrylic acid hydroxylethyl and the like. Each of thickness of the adhesive layers 12 and 17 is usually respectively about 15 to 30 μm.

A method for producing the laminate polarizing plate of the invention is explained. As afore-explained by referring FIG. 2, the invention preferably employs a method that the coating layer 15 having refractive index anisotropy is formed on the transfer substrate 20, followed by the resultant coating layer being transferred to the adhesive layer 12 on the polarizing plate 11. Employment of this method allows a procedure for drying the coating layer to be carried out at the outside on the polarizing plate, and results in advantageously producing the laminate polarizing plate without disadvantages of thermal degradation of polarizing plate or troubles of the coating layer due to lack of drying.

A transfer substrate 20 used in the present invention is a pre-treated film to easily peel off a layer formed on the surface thereof; the film is commercially available, generally, such as resin films of polyethylene terephthalate and the like of which surface is processed with treatment of mould release by coating mould release such as a silicone resin, a fluoric resin and the like. In order to form the coating layer 15 on the transfer substrate 20, a water contact angle of the transfer substrate 20 is preferably 90 to 130°, the water contact angle is further preferably equal to or more than 100° or equal to or less than 120°. If the water contact angle is less than 90°, the peel-off ability of the transfer substrate 20 is not sufficient, tending to cause defects such as phase retardation irregularity and the like in the phase retarder film including the coating layer 21. If the water contact angle is more than 130°, an un-dried coating solution an the transfer substrate 20 often exhibits repelling property, resulting in-plane phase retardation irregularity. The water contact angle mentioned here means a contact angle with a water used as liquid, and means that the larger the angle (upper limit value being 180°) is, the less wetting ability is.

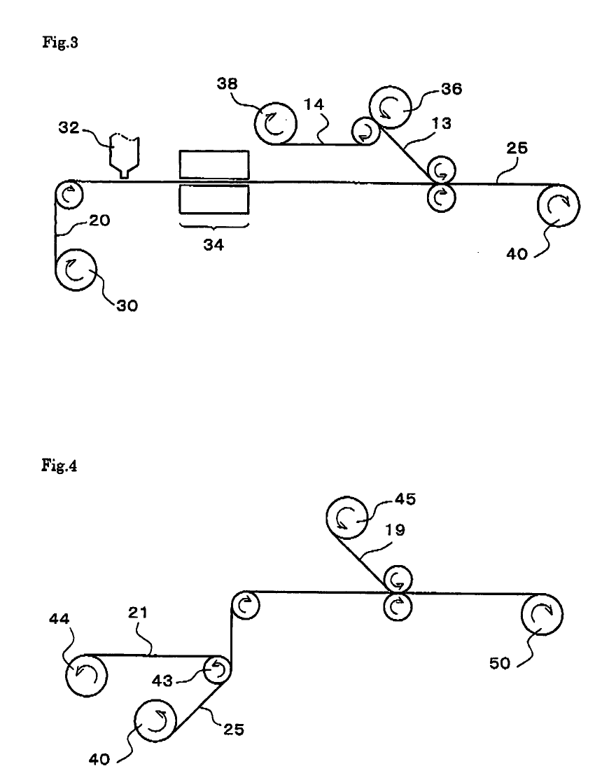

As also afore-explained by referring FIG. 2, especially (E) thereof, the second adhesive layer 17 may be disposed to the outer side of the phase retarder 15 including coating layer. When the second adhesive layer 17 is disposed, it is advantageous to follow the following sequential two steps: a first step that the coating layer 15 is formed on the transfer substrate 20, followed by the exposed face of the coating layer 15 being layered with the adhesive layer 12 of the polarizing plate 11; and a second step that, along with peeling the transfer substrate 20 away from the coating layer 15 layered with the polarizing plate, the second adhesive layer 17 is formed on a surface of the coating layer 15 which being peeled away from the transfer substrate, For the case of the laminate polarizing plate being produced in a rolled form, an outline of the first step described above is exemplified by a side view in FIG. 3, and an outline of the second step described above is exemplified by a side view in FIG. 4.

In the first step, the coating layer having refractive index anisotropy is formed on the transfer substrate, followed by the adhesive layer of the polarizing plate being adhered with the air exposed surface of this coating layer and then being rolled in. This step is explained in more detail by referring to FIG. 3; the surface of the transfer substrate 20 which is unrolled out from a transfer substrate roller 30, is coated with a coating solution for coating layer by a coating layer coater 32, followed by being dried by passing through a coating layer drying zone 34, and then being subjected to adhesion with the polarizing plate with adhesive 13. Since the polarizing plate with adhesive 13 is usually supplied in a form that a peelable release film is pre-adhered on the surface of the adhesive layer, the release film of polarizing plate 14 is firstly peeled away from the polarizing plate with adhesive 13 which is unrolled out from a polarizing plate roller 36, followed by being rolled by a release film rolling in roller 38. Then, a surface exposing the adhesive layer of the polarizing plate with adhesive 13 is adhered on the surface of the coating layer formed on the transfer substrate described above, and results in a semi-finished product 25 constituted by layers of polarizing plate/adhesive layer/coating layer/transfer substrate, and then being rolled in a semi-finished product roller 40.

This first step has advantages compared to conventional methods; wherein the conventional methods have steps that an air-exposed surface of coating layer is adhered with a protecting film, followed by being rolled in, then the rolled film is again unrolled out, followed by being adhered with a polarizing plate along with peeling the protecting film away; wherein the advantages are reduction of processing steps and production cost, elimination of defect derived from incomplete peeling off leaving pieces of respective films on each other's surface, and elimination of foreign substance caused by the protecting film; and these advantages allow to obtain the semi-finished product 25 in quite excellent qualities. Moreover, the application of side tape is also an advantageous technology; wherein the tape is employed to inhibit the surfaces of the semi-finished product from contacting each other, for the purpose to avoid migration of mould releasing agent of the transfer substrate 20 to the coating layer due to the pressure derived from rolling the semi-finished product.

Coating methods employed in the first step of the invention, are not particularly limited, various conventional coating methods can be employed such as a direct gravure method, a reverse gravure method, a die coating method, a comma coating method, a bar coating method and the like. Of these, the comma coating method, the die coating method without applying back-up roll, and the like are preferably employed due to excellent thickness precision.

The consecutive second step is carried out, along with by peeling the transfer substrate away from the semi-finished product produced in the first step, by forming an adhesive layer on the thus peeled coating surface, that is, by providing adhesive treatment thereon. This step is explained in more detail by referring FIG. 4; the semi-finished product 25 once rolled in the semi-finished product roller 40 in the first step shown in FIG. 3, is again unrolled out from the same roller 40, followed by being peeled away from the transfer substrate 21 by a transfer substrate peeling off roller 43; and then the coating layer surface exposed by peeling is supplied with a film with adhesive 19 unrolled out from a film with an adhesive roller 45 in order to be adhered with the adhesive layer side of the adhesive film, followed by the coating layer and the adhesive film being adhered each other to obtain a product and then the product being rolled in a product roller 50. The transfer substrate 21 peeled away from the semi-finished product 25 is rolled in a transfer substrate rolling in roller 44. Although the figure shows a case that the film with adhesive 19 is employed to form the second adhesive layer, as aforementioned, the adhesive may be directly coated on the coating layer. Through these first and second steps, the laminate polarizing plate which being disposed with polarizing plate/adhesive layer/coating layer/adhesive layer in the order, is obtained.

The first step shown in FIG. 3 and the second step shown in FIG. 4 may be consecutively combined. The example of this case shown in FIG. 5 as a schematic side view. In FIG. 5, parts corresponding to the parts exhibited in FIG. 3 and 4 are represented by the same signs used therein, and detail explanations thereabout are omitted. In this example, the surface of the transfer substrate 20 unrolled out from the transfer substrate roller 30, is coated with a coating solution for the coating layer by the coating layer coater 32, followed by being dried during passing through the coating layer drying zone 34, and then the resultant coated side thereof is adhered with the adhesive layer side of the polarizing plate with adhesive 13 which is unrolled out from the polarizing plate roller 36 and then peeled away from the release film of polarizing plate 14; consequently, the semi-finished product 25 having a layer structure of polarizing plate/adhesive layer/coating layer/transfer substrate, is obtained; procedures described herein are same to that of the first step shown in FIG. 3.

After the above procedures, the semi-finished product 25 is passed through a semi-finished product turning roller 41 without being rolled in, followed by peeling the transfer substrate off by a transfer substrate peeling off roller 43, and then the transfer substrate after peeled off 21 being rolled on a transfer substrate rolling in roller 44. On the other hand, the surface of coating layer after peeling away the transfer substrate 21, is coated with an adhesive by an adhesive coater 46, followed by being dried during passing through a adhesive drying zone 47; and then the resultant coated surface is adhered with a release film 18 unrolled out from a release film roller 48 to obtain a product and then this product is rolled in a product roller 50. Although, in this example, a direct coating-drying method employing the adhesive coater 46 and the adhesive drying zone 47 is exhibited in order to form the second adhesive layer, the method of applying the adhesive film as shown in FIG. 4, may be employed as alternation.

If the coating layer 15 is left for long time under contacting with the transfer substrate 20, the mould releasing agent on the transfer substrate 20 migrates to the coating layer 15, this often results in an increase of a water contact angle of the surface of the coating layer 15 which being peeled away from the transfer substrate 20 (the substrate is represented by a sign of 21 after being peeled off). In view of adhesive ability between the surface of the coating layer 15 peeled away from the transfer substrate 21 and the second adhesive layer 17; the procedures of peeling the transfer substrate and coating an adhesive in the second step, is preferably carried out under the condition that the increase of a water contact angle of the surface of the coating layer 15 peeled away from the transfer substrate, is contained within 15°, preferably within 10°, in comparison with a water contact angle of the air-exposed surface of the coating layer 15 when the coating layer 15 is formed on the transfer substrate 20 (refer to FIG. 2(B)). For this purpose, it is preferable to shift to the second step as soon as possible after finishing the first step. Furthermore, when the adhesive processing is provided for the coating layer 15 which being peeled away from the transfer substrate 21, it is also technologically useful that either surface of the coating layer 15 or the second adhesive layer 17 is subjected to corona treatment.

In FIGS. 3 to 5, curled arrows indicate a direction of rotation of rollers.

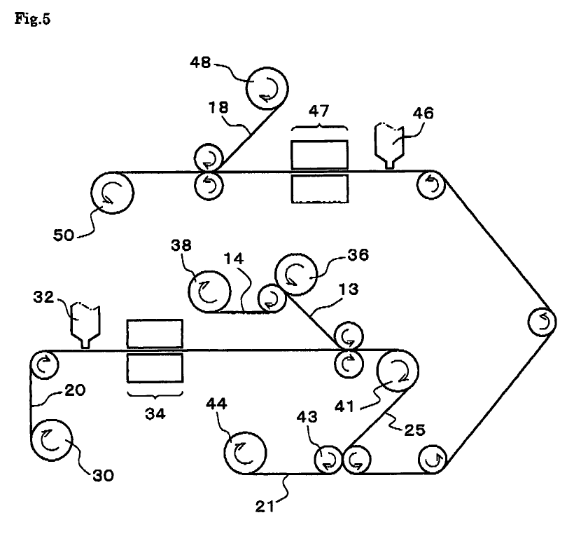

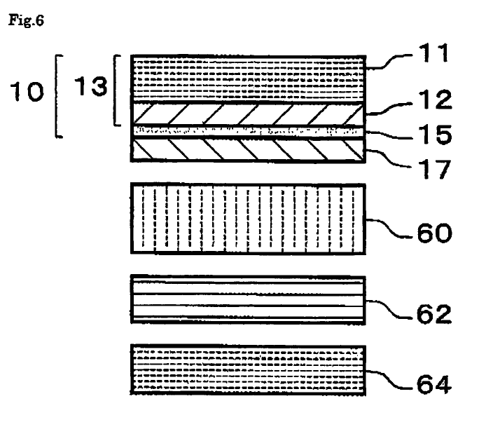

The liquid crystal display is explained. The liquid crystal display of the invention, as an example of its constitution being shown in a schematic sectional view of the FIG. 6, is constituted as follows; on the one side of a liquid crystal cell 60, the laminate polarizing plate 10 explained above is disposed by facing the side of the phase retarder 15 thereof toward the cell, by usually being interposed with the second adhesive layer 17; and on the other side of the liquid crystal cell 60, the second phase retarder 62 and the second polarizing film 64 are disposed in this order.

The second phase retarder 62 disposed between the liquid crystal cell 60 and the second polarizing film 64, is constituted by the one of which in-plane retardation value R₀ is 30 to 300 nm and a ratio R₀/R′ of in-plane retardation value R₀ to retardation value R′ in the film-thickness direction is larger than 0 and less than 2, that is, 0<R₀/R′<2. The combination of the phase retarder having such refractive index anisotropy characteristics with the above described laminate polarizing plate of the invention, allows to improve viewing angle characteristics of liquid crystal displays. The phase retarder providing such refractive index anisotropy characteristics may be, for example, produced by a method of subjecting un-processed raw polymer films to fixed-end mono-orientation, specifically fixed-end transversal mono-orientation by applying a tenter and the like. The R₀/R′ of the second phase retarder 62 is preferably in a range of 0.8 to 1.4 due to being easily produced by the fixed-end mono-orientation method and providing favorable optical property to liquid crystal displays. The R₀/R′ may be equal to or less than 1.3.

Materials applied to the second phase retarder 62 is not particularly limited, for example, may include cyclcolefin resins composed of polycyclic olefin monomers such as polycarbonate, polyurethane and norbornene, celluloses, polyolefins, coplymers composed of at least two monomers consisting of these polymers, and the like. In view of optical stability under conditions of high temperature and humidity, or tensioned state, preferable is the cyclicolefin resins having small photoelastic coefficient. In the second phase retarder 62, wave length dependency of phase retardation value is also not particularly limited; in view of suppression of apparent coloration, preferable is the one having a phase retardation distribution in which phase retardation value decreases along with shift of light to short wavelength side.

The second polarizing plate 64, as well as the polarizing plate 11 afore-explained by referring FIG. 1, may be a polyvinylalcohol polarizer having absorbed and oriented dichroic dye in which a protecting layer of a polymer film is formed on one or both sides thereof.

It is preferable to dispose the protecting layer at least at the exposed surface of the second polarizing plate 64 (bottom side in the FIG. 6). Alternatively, the second phase retarder 62 may be directly adhered to the polarizer of second polarizing plate 64 by applying adhesive or binder in place of the protecting layer protecting one side of the second polarizing plate 64. In this case, the second polarizing plate 64 has the protecting layer only at one side of the linear polarizer thereof and is laminated with the second phase retarder 62 at the side having no protecting layer.

The second polarizing plate 64 and the second phase retarder 62 may be aligned in the manner that an absorption axis of the former crosses the slow axis of the latter in a range of 80 to 100°, preferably the axis angle between them being 85 to 90° in view of high contrast ratio and reduction of color irregularity. Still more preferably, the axis angle between them is set in a range 89 to 91°.

Furthermore, although a figure being abbreviated, an adhesives such as acrylic resins and the like may be applied to adhere the liquid crystal cell 60 and the second phase retarder 62. The adhesives such as acrylic resins and the like may be also applied to adhere the second phase retarder 62 and the second polarizing plate 64, especially when the second polarizing plate 64 has the protecting layers on both sides thereof. The acrylic resin adhesives are same to the afore-explained.

When the liquid crystal display shown in the FIG. 6 is used as transmissive type, a backlight is disposed either at the outer side of the laminate polarizing plate 10 thereof or at the outer side of the second polarizing plate 64 thereof. The backlight may be disposed either side. Therefore, a first embodiment of the liquid crystal display disposes the compound polarizing plate 10 of the invention at the front side of the liquid crystal cell 60 (the visible side), and the second phase retarder 62 and the second polarizing plate 64 at the rear side (the backlight side in the case of the transmissive type). A second embodiment of the liquid crystal display disposes the laminate polarizing plate 10 at the rear side of the liquid crystal cell 60, and the second phase retarder 62 and the second polarizing plate 64 at the front side. In these disposition arrangement, axis angles of each layer are adjusted to have optimal viewing angle characteristics.

The laminate polarizing plate in which the phase retarder of the invention is layered with the polarizing plate, can be effectively applied to improve viewing angle characteristics of liquid crystal displays of various modes such as vertical alignments (VA), twisted nematics (TN), optically compensated birefringents (OCB) and the like.

### EXAMPLE

The present invention is explained in more detail referring Examples, but should not be limited thereto. In the Examples, the term of % representing amount contained or used is based on weight as far as without particular remarks. The materials used for forming coating layers in the following Examples are as follows.

(A) Organic Modified Clay Composite

Trade name “Lucentite STN”: manufactured by CO-OP Chemical, which is the composite of the synthetic hectorite and trioctylmethyl amounium ion.

Trade name “Lucentite SPN”: manufactured by CO-OP Chemical, which is the composite of the synthetic hectorite and polyoxypropylene (25) methyldiethyl ammonium ion, wherein “polyoxypropylene (25)” means it has twenty-five of oxypropylene units.

(B) Binder

(B-1) Trade name “SBU Lacquer 0866”: manufactured by Sumika Bayer Urethane Co., Ltd., urethane resin varnish containing 30% by weight of solid concentration based on Isophorone Diisocyanate

(B-2) Trade name “Arontack S1601”: manufactured by TOAGOSEI Co., Ltd., Acrylic resin varnish

Measurement and evaluation of the physical properties of samples were carried out according to the following methods.

(1) In-Plane Retardation Value R₀

The coating layer formed on the transfer substrate was transferred to the glass plate of 4 cm square interposing the adhesive. The measurement was carried out in the state affixed on the glass plate by “KOBRA-21 ADH” manufactured by Oji Scientific Instruments about the in-plane retardation value R₀ with the rotary analyzer method using monochromatic light of 559 nm wave length. The in-plane retardation value R₀ of the phase retarder film made of an elongated resin film was directly measured by “KOBRA-21 ADH” described above.

(2) Retardation Value in the Thickness Direction R′

By using the in-plane retardation value R₀, the retardation value R₄₀ measured in 40° aslant state by applying the in-plate slow axis as the inclined axis, the film thickness d and the average refractive index of film n₀, the nₓ, n_{y} and n_{z} were obtained from the aforementioned method, followed by calculation of the retardation value in the thickness direction R′ according to the formula (II) described above.

(3) Haze Value

The haze value of phase retarder formed by coating on a glass plate, is measured by the haze meter “HGM-2DP” manufactured by Suga Test Instruments Co., Ltd.

(4) Contrast

A liquid crystal display disposed with a predetermined polarizing plate, is controlled to develop black indication or white indication by adequate combination with a backlight; then, the contrast in the normal line direction on a face of the display (i.e. the front contrast) is measured by the viewing angle dependent brightness meter “EZ-Contrast” manufactured by ELDIM. Herein, the contrast is defined by a ratio of brightness of black indication to that of white indication.

### Example 1

(a) Production of Coating Phase Retarder

A coating solution having following composition was prepared.

Urethane resin varnish “SBU lacquer 0866” 10%

Organic modified clay composite “Lucentite STN” 9%

Toluene 81%

The solid content concentration of the coating solution was 12%, and the solid content weight ratio of organic modified clay composite by urethane resin was 3/1. This coating solution was coated by an applicator on a polyethylene terephthalate film of which thickness was 38 μm and which was subjected to mould releasing treatment (the water contact angle of the surface treated by mould releasing agent was 110°), followed by being dried at 50° C. for 1 minute and then additionally dried at 90° C. for 3 minutes to obtain a phase retarder coated on the film. The phase retardation value of the coating layer was measured, the measurement results were R₀=0.2 nm and R′=94 nm. The haze value of a phase retarder coated on a glass plate by the same manner, was 0.6%.

(b) Production of Compound Phase Retarder

The exposed surface of coating layer of the phase retarder produced in the above step (a), was adhered with the adhesive side of a polarizing plate (manufactured by Sumitomo Chemical, trade name “SUMIKARAN SRW842A”) which is a polyvinylalcohol-iodine system polarizer having protecting layers on both faces thereof and adhesive layer at one side thereof, to produce a semi-finished product having a layer structure of polarizing plate/adhesive layer/coating layer/release film. Thereafter, the surface of coating layer after peeling the release film away, was adhered with the adhesive side of a polyethylene terephthalate film in which an adhesive being independently coated on the surface subjected to mould releasing treatment, to produce a laminate polarizing plate having a layer structure of polarizing plate/adhesive layer/coating layer/adhesive layer/release film.

(c) Production and Evaluation of Liquid Crystal Display

A liquid crystal display was produced as follows: the release film was peeled away from the laminate polarizing plate which being produced in the above step (b) and having the layer structure of polarizing plate/adhesive layer/coating layer/adhesive layer/release film, and then this laminate polarizing plate is layered on the upper face of a VA type liquid crystal cell (commercial product) by interposing the adhesive layer; the second phase retarder which being composed of a elongated film of cyclic polyolefin and having in-plane retardation value of R₀=100 nm and retardation value in the film-thickness direction R′=130 nm, was layered on the lower face of the liquid crystal cell by interposing an adhesive layer; and a second polarizing plate (manufactured by Sumitomo Chemical, trade name “SUMIKARAN S00642A”) which is a polyvinylalcohol-iodine system polarizer having protecting layers at one side thereof, was layered on the further lower face of this second phase retarder by interposing an adhesive in a manner that a protective layer of the second polarizing plate is the lowest layer of the lower face. In this production, the laminate polarizing plate and the second polarizing plate were aligned in a manner that absorption axes thereof crossed each other in an angle of 90°, and the second polarizing plate and the second phase retarder were aligned in a manner that absorption axis of the former crossed slow axis of the latter in an angle of 90+. The result of contrast measurement on the liquid crystal display was 706.6.

### Comparative Example 1

(a) Production of Coating Phase Retarder

A coating solution having following composition was prepared.

acrylic resin varnish “Arontack S1601” 10%

Organic modified clay composite “Lucentite STN” 9%

Toluene 81%

The solid content concentration of the coating solution was 12%, and the solid content weight ratio of organic modified clay composite by acrylic resin was 3/1. This coating solution was coated by the same conditions applied in Example 1 on a polyethylene terephthalate film of which thickness was 38 μm and which was subjected to mould releasing treatment, followed by being dried to obtain a phase retarder coated on the film. The phase retardation value of the coating layer was measured, the measurement results were R₀=0.1 nm and R′=82 nm. The haze value of a phase retarder coated on a glass plate by the same manner, was 3.5%.

(b) Production of Compound Phase Retarder

By applying the phase retarder produced in the above step (a), a semi-finished product having a layer structure of polarizing plate/adhesive layer coating layer/release film, was produced according to the manner applied in (b) of Example 1; thereafter, a laminate polarizing plate having a layer structure of polarizing plate/adhesive layer/coating layer/adhesive layer/release film, was produced.

(c) Production and Evaluation of Liquid Crystal Display

By applying the laminate polarizing plate produced in the above step (b) which having the layer structure of polarizing plate/adhesive layer/coating layer/adhesive layer/release film, a liquid crystal display was produced according to the manner applied in (c) of Example 1. The result of contrast measurement on the liquid crystal display was 635.0.

### Comparative Example 2

(a) Production of Coating Phase Retarder

A coating solution having following composition was prepared.

acrylic resin varnish “Arontack S1601” 10%

Organic modified clay composite “Lucentite STN” 6.8%

Organic modified clay composite “Lucentite SPN” 2.2%

Toluene 45.8%

Acetone 35.2%

The solid content concentration of the coating solution was 12%, and the solid content weight ratio of organic modified clay composite by acrylic resin was 3/1. This coating solution was coated by the same conditions applied in Example 1 on a polyethylene terephthalate film of which thickness was 38 μm and which was subjected to mould releasing treatment, followed by being dried to obtain a phase retarder coated on the film. The phase retardation value of the coating layer was measured, the measurement results were R_{0b =0.1} nm and R′=84 nm. The haze value of a phase retarder coated on a glass plate by the same manner, was 2.0%.

(b) Production of Compound Phase Retarder

By applying the phase retarder produced in the above step (a), a semi-finished product having a layer structure of polarizing plate/adhesive layer/coating layer/release film, was produced according to the manner applied in (b) of Example 1; thereafter, a laminate polarizing plate having a layer structure of polarizing plate/adhesive layer/coating layer/adhesive layer/release film, was produced.

(c) Production and Evaluation of Liquid Crystal Display

By applying the laminate polarizing plate produced in the above step (b) which having the layer structure of polarizing plate/adhesive layer/coating layer/adhesive layer/release film, a liquid crystal display was produced according to the manner applied in (c) of Example 1. The result of contrast measurement on the liquid crystal display was 645.9.

### Comparative Example 3

(a) Production of Coating Phase Retarder

A coating solution having following composition was prepared.

Urethane resin varnish “SBU lacquer 0866” 13.3%

Organic modified clay composite “Lucentite STN” 6.0%

Organic modified clay composite “Lucentite SPN” 2.0%

Toluene 78.7%

The solid content concentration of the coating solution was 12%, and the solid content weight ratio of organic modified clay composite by acrylic resin was 2/1. This coating solution was coated by the same conditions applied in Example 1 on a polyethylene terephthalate film of which thickness was 38 μm and which was subjected to mould releasing treatment, followed by being dried to obtain a phase retarder coated on the film. The phase retardation value of the coating layer was measured, the measurement results were R₀=0.2 nm and R′=88 nm. The haze value of a phase retarder coated on a glass plate by the same manner, was 1.7%.

(b) Production of Compound Phase Retarder

By applying the phase retarder produced in the above step (b), a semi-finished product having a layer structure of polarizing plate/adhesive layer/coating layer/release film, was produced according to the manner applied in (b) of Example 1; thereafter, a laminate polarizing plate having a layer structure of polarizing plate/adhesive layer/coating layer/adhesive layer/release film, was produced.

(c) Production and Evaluation of Liquid Crystal Display

By applying the laminate polarizing plate produced in the above step (b) which having the layer structure of polarizing plate/adhesive layer/coating layer/adhesive layer/release film, a liquid crystal display was produced according to the manner applied in (c) of Example 1. The result of contrast measurement on the liquid crystal display was 662.0.

The phase retarder of the invention contains the haze value small; and the compound polarizing plate including layers of the phase retarder and a polarizing plate, has thin thickness, simplified structure and favorable optical characteristics. A liquid crystal display is obtained by disposing the laminate polarizing plate on the one side of a liquid crystal cell and also disposing another phase retarder (second phase retarder) having different optical characteristics together with a second polarizing plate on the other side of the liquid crystal cell, wherein the optical properties, especially on contrast, of this liquid crystal display is equal to or superior to that of the conventional vertical-alignment mode liquid crystal displays which being structured by disposing each one of biaxial phase retarders respectively on and under a liquid crystal cell.

What is claimed is:

1. A phase retarder comprising a film which comprises a compound comprising an organic modified clay composite, and a urethane resin which comprises aliphatic diisocyanate, wherein the weight ratio of the former to the latter is more than 2 to less than 5.

2. The phase retarder according to claim 1, wherein the aliphatic diisocyanate is isophorone diisocyanate.

3. The phase retarder according to claim 1 or 2, wherein the organic modified clay composite comprises a quaternary ammonium compound having alkyl group having 1 to 30 carbon atoms and a clay mineral belonging to smectite group.

4. The phase retarder according to claim 1, wherein the haze value of the phase retarder is equal to or less than 1.5%.

5. The phase retarder according to any claim 1, wherein the in-plane retardation value of the phase retarder is 0 to 10 nm and the retardation value in the film-thickness direction of the phase retarder is 40 to 300 nm.

6. A method for producing a phase retarder, wherein a compound containing an organic modified clay composite, a urethane resin comprising aliphatic diisocyanate, and an organic solvent is coated on a substrate, and the organic solvent is removed therefrom.

7. A laminate polarizing plate having a polarizing plate, an adhesive and the phase retarder according to claim 1, in this order.

8. The laminate polarizing plate according to claim 7, wherein a second adhesive layer is further placed outer side of the phase retarder.

9. A method for producing laminate polarizing plate comprising layering a polarizing plate, an adhesive and a phase retarder in this order, wherein the method comprises:
a step of forming the phase retarder by coating on a substrate a compound containing an organic modified clay composite and a urethane resin comprising aliphatic diisocyanate;
a step of preparing the polarizing plate having an adhesive;
a step of adhering the adhesive layer of the polarizing plate having an adhesive, with the exposed surface of the coated phase retarder; and then
a step of peeling the substrate away from the coated phase retarder.

10. A liquid crystal display comprising:
a liquid crystal cell;
the laminate polarizing plate according to claim 7 or 8 which is disposed on the one side of the liquid crystal cell in a manner that its phase retarder being faced towards the liquid crystal cell rather than its polarizing plate being;
a second phase retarder which is placed on the other side of the liquid crystal cell and of which in-plane retardation value (R₀) is 30 to 300 nm and ratio (R₀/R′) of the in-plane retardation value (R₀) to the retardation value (R′) in the film-thickness direction is more than 0 and less than 2; and
a second polarizing plate which is placed on the second phase retarder at the opposite side thereof against the liquid crystal cell.
